(19) United States
(12) Patent Application Publication
(10) Pub. No.: US 2024/0322303 A1
(43) Pub. Date: Sep. 26, 2024

(54) BATTERY

(71) Applicant: ZHUHAI COSMX POWER CO., LTD., Zhuhai (CN)

(72) Inventors: Yanqing WANG, Zhuhai (CN); Yanzhen ZONG, Zhuhai (CN); Zihao LUO, Zhuhai (CN)

(21) Appl. No.: 18/736,372

(22) Filed: Jun. 6, 2024

Related U.S. Application Data
(63) Continuation of application No. PCT/CN2023/080424, filed on Mar. 9, 2023.

(51) Int. Cl. H01M 50/105; H01M 50/178; H01M 50/533

(52) U.S. Cl. CPC H01M 50/105; H01M 50/178; H01M 50/533

(57) ABSTRACT

A battery includes a battery cell body and a packaging member for encapsulating the battery cell body. The packaging member includes a top sealing edge and side sealing edges located on two opposite sides of thereof. A first end of each side sealing edge extends to an outer side of a top surface of battery cell body. The top sealing edge includes a main body portion and end portions respectively located on two sides of main body portion, the main body portion is disposed on the top surface in a tiled manner, and each end portion is connected to the first end of side sealing edge. A side of end portion facing away from the top surface is flat; and/or the end portion is attached to an inner side of first end, and a side of first end facing away from the top surface is flat.

### CROSS-REFERENCE TO RELATED APPLICATION

This present application is a continuation of International Application No. PCT/CN2023/080424, filed on Mar. 9, 2023, which claims priority to Chinese Patent Application No. 202220278411.7 filed on Feb. 10, 2022. The disclosures of the aforementioned application are hereby incorporated by reference in their entireties.

### TECHNICAL FIELD

The present disclosure relates to the field of battery technology, and in particular, a battery.

### BACKGROUND

Battery is a kind of component that converts chemical energy into electrical energy, which has very wide applications in daily life and work. A lithium-ion battery, for example, is often used in various electronic devices such as mobile phones, cameras, laptops and tablets to provide power source for electronic devices. It plays a very important role in people's life and work.

The lithium-ion battery includes a steel shell lithium battery and a soft pack lithium battery. For example, the soft pack lithium battery includes a battery cell body on which a tab extending outward is provided, and the battery cell body is packaged with a packaging member for encapsulating the battery cell body and leading out only the tab on the battery cell body to connect it with other circuit structures of the electronic device. Generally, the packaging member includes an accommodating area for sealing the battery cell body and packaging edges located around the accommodating area, where a packaging edge with a tab extending is usually called a top sealing edge, and packaging edges which are perpendicular to the top sealing edge and located on both sides of the accommodating area are two side sealing edges. Where, an extension direction of the top sealing edge is consistent with an extension direction of the tab, and the top sealing edge is perpendicular to a top surface of the battery cell body.

However, larger space occupied by the top sealing edge will reduce the size proportion of the battery cell body, and reduce the unit volume capacity of the battery cell body, thereby lowering the energy density of the battery.

### SUMMARY

The disclosure provides a battery to solve the problem in existing battery that the top sealing edge of the packaging member occupying a larger space cause the size proportion of the battery cell body to be reduced and the energy density of the battery to be lowered.

The present application provides a battery, including: a battery cell body and a packaging member, the packaging member encapsulating the battery cell body, where
the packaging member includes a top sealing edge and side sealing edges located on opposite sides of the top sealing edge, and a first end of each side sealing edge extends to an outer side of a top surface of the battery cell body;
the top sealing edge includes a main body portion and end portions respectively located on both sides of the main body portion, and the main body portion is disposed on the top surface in a tiled manner;
each end portion is connected to the first end, and a side of the end portion facing away from the top surface is flat;
and/or, each end portion is attached to an inner side of the first end, and a side of the first end facing away from the top surface is flat.

That is to say, in the present application, the main body portion of the top sealing edge is parallel to the top surface of the battery cell body, and the main body portion is laid on the top surface of the battery cell body. Compared with the manner of setting the top sealing edge perpendicular to the top surface of the battery cell body, it can effectively reduce the size of the top sealing edge in the height direction, thus reducing the space occupied by the top sealing edge in the battery, and improving the space proportion of the battery cell body in the battery, increasing the size of the battery cell body, enhancing the unit volume capacity of the battery cell body, effectively improving the energy density of the battery, and improving the endurance capability of the battery.

Moreover, a side of the end portion of the top sealing edge facing away from the top surface is flat, that is, the side of the end portion facing away from the top surface is flat structure instead of a sharp angle structure. This can effectively avoid the sharp angle structure appearing in the packaging member, and prevent the battery from the security incident caused by the sharp angle structure in the process of use or transportation, such as scratch or bump.

The configuration of package structure is simple and easy to implement, which can reduce the work difficulty of encapsulating with the packaging member, cut down the cost of encapsulating the battery cell body and improve the work efficiency of encapsulating the battery cell body effectively.

In a possible implementation, when the side of the end portion facing away from the top surface is flat, the side of the end portion facing away from the top surface and the side of the first end facing away from the top surface are located in the same plane, and the plane is parallel to the top surface.

In a possible implementation, in a length direction of the battery cell body, a length of the end portion is 2 mm-6 mm.

In a possible implementation, the top sealing edge further includes a transition portion, and the main body portion and the end portion are connected by the transition portion, and an incline angle is formed between the transition portion and the main body portion.

In a possible implementation, the incline angle between the transition portion and the main body portion has an angle of 90°-150°.

In a possible implementation, in a height direction of the battery cell body, a height of the end portion is 1 mm-3 mm.

In a possible implementation, in a width direction of the battery cell body, the main body portion extends from a first side of the top surface to a second side of the top surface, and the main body portion covers part of the top surface.

In a possible implementation, the battery further includes a tab, the tab includes a bending part and an extension part that are connected each other, the bending part is connected with the battery cell body, part of the main body portion encapsulates the bending part, the bending part is disposed on the top surface in a tiled manner, and the extension part is perpendicular to the top surface.

In a possible implementation, a distance between an end of the bending part facing the second side of the top surface and the second side of the top surface is greater than 0.2 mm.

In a possible implementation, the tab includes a positive electrode tab and a negative electrode tab, and a sum of a number of the positive electrode tab and a number of the negative electrode tab is two or more.

### BRIEF DESCRIPTION OF DRAWINGS

To illustrate the technical solutions in embodiments of the present application or in the prior art more clearly, the accompanying drawings required for describing the embodiments or the prior art are briefly described below. Apparently, the accompanying drawings in the following description illustrate merely some embodiments of the present application, and persons of ordinary skill in the art may still derive other drawings from these accompanying drawings without creative effort.

FIG. 1 is a structural schematic diagram of an existing battery.

FIG. 2 is a structural schematic diagram of a battery provided in an embodiment of the present application.

FIG. 3 is a front view of a battery provided in an embodiment of the present application.

FIG. 4 is a partial schematic diagram of another battery provided in an embodiment of the present application.

FIG. 5 is a structural schematic diagram of another battery provided in an embodiment of the present application.

FIG. 6 is an enlarged view of region A in FIG. 5.

FIG. 7 is a front view of another battery provided in an embodiment of the present application.

FIG. 8 is an enlarged view of region B in FIG. 5.

FIG. 9 is a front view of another battery provided in an embodiment of the present application.

### DESCRIPTION OF REFERENCE NUMBERS

100—battery;
10—battery cell body;
11—top surface;
111—first side;
112—second side;
20—packaging member;
21—top sealing edge;
211—main body portion;
212—end portion;
213—transition portion;
22—side sealing edge;
221—first end;
30—tab;
31—bending part;
32—extension part.

### DESCRIPTION OF EMBODIMENTS

To make the objectives, technical solutions, and advantages of the present application clearer, the following clearly and comprehensively describes the technical solutions in the present application with reference to the accompanying drawings in the present application. Apparently, the described embodiments are merely a part rather than all of embodiments of the present application. All other embodiments obtained by persons of ordinary skill in the art based on embodiments of the present application without creative effort shall fall within the protection scope of the present application.

FIG. 1 is a structural schematic diagram of an existing battery.

With the continuous development and updating of battery technology, the endurance capability of the battery is getting more and more attention. Usually, the endurance capability of the battery is determined by the size of the battery cell body, that is, the larger the size of the battery cell body in the battery, the more favorable it is to improve the endurance capability of the battery.

Just as the content in the above technical field, referring to FIG. 1, at present, in the packaging structure of the soft pack lithium battery, the top sealing edge 202 of the packaging member is usually extended along a height direction of the battery cell body 201 (that is, y direction in FIG. 1) together with the tab 203, that is, the top sealing edge 202 is set perpendicular to the top surface 2011 of the battery cell body 201. In this way, the top sealing edge 202 occupies a larger space in the battery 200, which reduces the occupation space of the battery cell body 201 in the battery 200 and lowers the size of the battery cell body 201, thereby reducing the unit volume capacity of the battery cell body 201 and the energy density of the battery 200, and being not conducive to the improvement of endurance capability of the battery 200.

Based on the above problems, the embodiment of the present application provides a battery that can effectively reduce the space occupied by the top sealing edge, thereby improving the size of the battery cell body, increasing the unit volume capacity of the battery cell body, and enhancing the endurance capability of the battery.

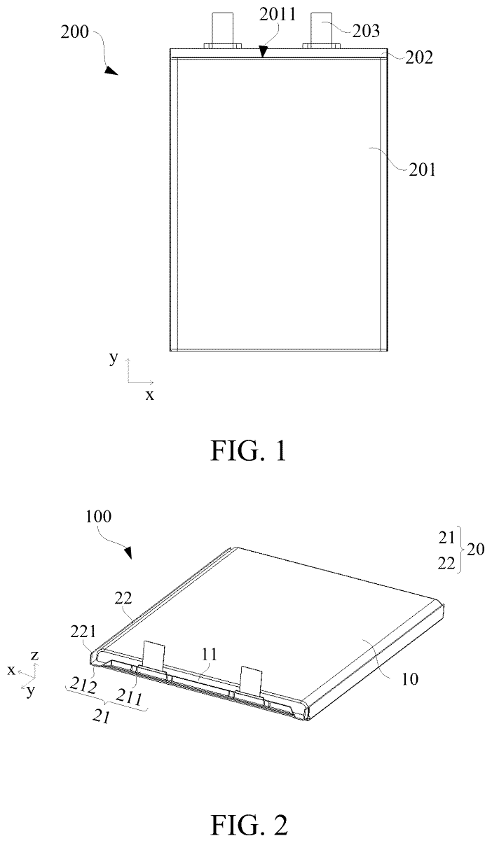

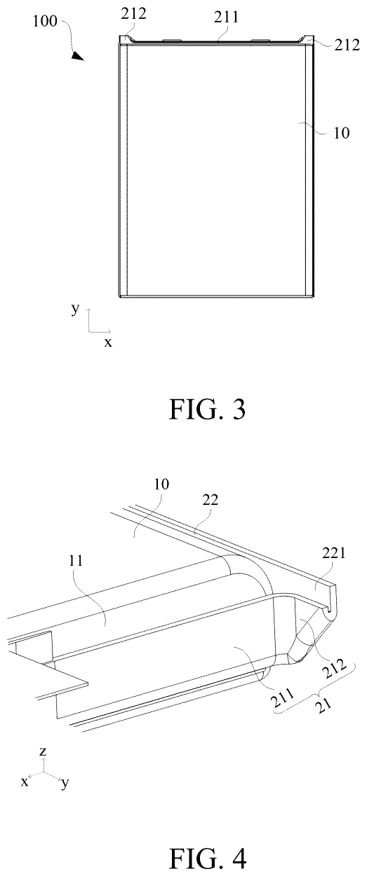

FIG. 2 is a structural schematic diagram of a battery provided in an embodiment of the present application; FIG. 3 is a front view of a battery provided in an embodiment of the present application; and FIG. 4 is a partial schematic diagram of another battery provided in an embodiment of the present application.

An embodiment of the present application provides a battery, as shown in FIG. 2, including a battery cell body 10 and a packaging member 20, where the packaging member 20 can encapsulate the battery cell body 10 to provide protection for the battery cell body 10 and prevent the battery cell body 10 from being damaged in the process of transportation or use of the battery 100, which will affect the normal use of the battery 100.

Where, the molding material of the packaging member 20 may be a laminated aluminum-plastic film. The laminated aluminum-plastic film has a smaller thickness and a lower weight, which can effectively reduce a weight of the battery 100 and is conducive to the lightweight design of the battery 100. Moreover, the laminated aluminum-plastic film is flexible in shape design and has a good flexibility and plasticity, which can meet the design requirements of different shapes and specifications of the battery 100, thereby improving the flexibility of the shape design of the battery 100.

Where, the battery 100 further includes a tab 30, which is connected with the battery cell body 10 to lead out current; and when the battery 100 is used, the tab 30 can be connected with the circuit structure of an electronic device to provide power for the electronic device. Specifically, the tab 30 can be extended from the top surface 11 of the battery cell body 10 to the outer side of the battery cell body 10, and part of the tab 30 extends outside the packaging member 20 when the packaging member 20 encapsulates the battery cell body 10.

In an embodiment of the present application, as shown in FIG. 2, the height direction of the battery cell body 10 is a direction from the battery cell body 10 to the tab 30, as shown by y direction of FIG. 2. A length direction of the battery cell body 10 is a direction perpendicular to the height direction, as shown by x direction of FIG. 2. A width direction of the battery cell body 10 is a direction perpendicular to both the height direction and the length direction, as shown by z direction of FIG. 2.

The packaging member 20 includes a packaging edge, which refers to a structure formed by an edge of packaging member 20 being closed along a periphery of the battery cell body 10. The packaging edge includes a top sealing edge 21 and side sealing edges 22, where the top sealing edge 21 refers to a packaging edge formed on the outer side of the top surface 11 of the battery cell body 10, and the tab 30 extends out of the top sealing edge 21. The side sealing edges 22 refer to packaging edges respectively located on the opposite sides of the battery cell body 10, that is, the side sealing edges 22 are located on the opposite sides of the top surface 11, and two side sealing edges 22 are located on the opposite sides of the top sealing edge 21 respectively.

Where, a first end 221 of the side sealing edge 22 extends to an outer side of the top surface 11 of the battery cell body 10, so as to facilitate the connection between the first end 221 of the side sealing edge 22 and the top sealing edge 21, thereby improving the overall packaging effect of the packaging member 20.

Referring to FIG. 2, the top sealing edge 21 includes a main body portion 211 and two end portions 212 respectively located on two sides of the main body portion 211. Where, two end portions 212 are located on both sides of the top surface 11 respectively and are connected with the side sealing edges 22 respectively. That is, two ends of the main body portion 211 are connected with the side sealing edges 22 by two end portions 212 respectively, so as to realize the connection of the top sealing edge 21 with the side sealing edges 22.

As shown in FIG. 3, the main body portion 211 can be disposed on top surface 11 in tiled manner, that is, an extension direction of the main body portion 211 of the top sealing edge 21 is parallel to the top surface 11 of the battery cell body 10, and the main body portion 211 of the top sealing edge 21 is laid on the top surface 11 of the battery cell body 10. Compared with the manner of setting the top edge sealing 202 (as shown in FIG. 1) to be perpendicular to the top surface 2011 of the battery cell body 201 in the existing battery, the size of the top edge sealing 21 in the height direction (that is, y direction in FIG. 3) can be effectively reduced, thus reducing the space occupied by the top edge sealing 21 in the battery 100, and improving the space proportion of the battery cell body 10 in the battery 100, increasing the size of the battery cell body 10, improving the unit volume capacity of the battery cell body 10, effectively improving the energy density of the battery 100, and enhancing the endurance capability of the battery 100.

Where, in combination with FIG. 2 and FIG. 3, the end portion 212 may be perpendicular to the top surface 11, and a side of the end portion 212 facing away from the top surface 11 is flat. That is, the side of the end portion 212 facing away from the top surface 11 is a flat structure instead of a sharp angle structure. This can effectively avoid the sharp angle structure appearing in the packaging member 20, and prevent the battery 100 from the security incident caused by the sharp angle structure in the process of use or transportation, such as scratch or bump, and improve the safety of the structure of the battery 100.

Or, referring to FIG. 4, the end portion 212 may also be attached to an inner side of the first end 221, and the side of the first end 221 facing away from the top surface 11 is flat, where the inner side of the first end 221 refers to a side of the first end 221 facing the battery cell body 10. This can also effectively avoid a sharp angle structure appearing in the packaging member 20, prevent the security incident caused by the sharp angle structure, such as scratch or bump, and improve the safety of the structure of the battery 100.

Or, it is also possible that a side of the end portion 212 at one side of the top scaling edge 21 facing away from the top surface 11 is flat, the end portion at the other side of the top scaling edge 21 is attached to an inner side of the first end 221, and a side of the first end 221 facing away from the top surface 11 is flat. In this way, it also can avoid the sharp angle structure appearing in the packaging member 20, and prevent the security incident caused by the sharp angle structure, such as scratch or bump.

Where, when the battery cell body 10 is encapsulated by the packaging member 20, after the encapsulation is completed, the packaging member 20 includes an accommodating area. The battery cell body 10 is located in the accommodating area, and a packaging edge is formed around the accommodating area. Where, the top sealing edge 21 is perpendicular to the top surface 11 of the battery cell body 10; and the main body portion 211 of the top scaling edge 21 may be tiled on the top surface 11 in a bending manner. For example, the main body portion 211 of the top sealing edge 21 is laid on the top surface 11 when the top sealing edge 21 is bent 90° in the direction of the battery cell body 10. At the same time, two end portions 212 of the top sealing edge 21 are perpendicular to the top surface 11, and the side of the end portion 212 facing away from the top surface 11 is flat. Or, the end portion 212 may also be attached inside the first end 221 and the side of the first end 221 facing away from the top surface 11 is flat to reduce the shape angle structure of the packaging member 20.

That is to say, after the encapsulation of the battery cell body 10 is completed, the main body portion 211 of the top sealing edge 21 is bent to obtain the above battery, so that there is no need to modify the encapsulation process and encapsulation device and change a packaging size of the packaging member 20 and the like, which will not damage the original packaging effect, and can effectively ensure the reliability and stability of encapsulating with the packaging member 20.

In the embodiment of the present application, the main body portion 211 is laid on the top surface 11, and an adhesive layer may be disposed between the main body portion 211 and the top surface 11. The adhesive layer may be bonded with the main body portion 211 and top surface 11 respectively to connect the main body portion 211 and top surface 11. This can further improve the reliability and firmness of the connection between the main body portion 211 and the battery cell body 10, thereby improving the structural stability and reliability of the packaging member 20.

For example, the above adhesive layer may be formed between the main body portion 211 and the top surface 11 by a dispensing process.

In addition, the packaging member 20 of the battery 100 is simple in structure and easy to implement, which can effectively reduce the working difficulty of encapsulating with the packaging member 20, lower the cost of encapsulating the battery cell body 10, and effectively improve the work efficiency of encapsulating the battery cell body 10.

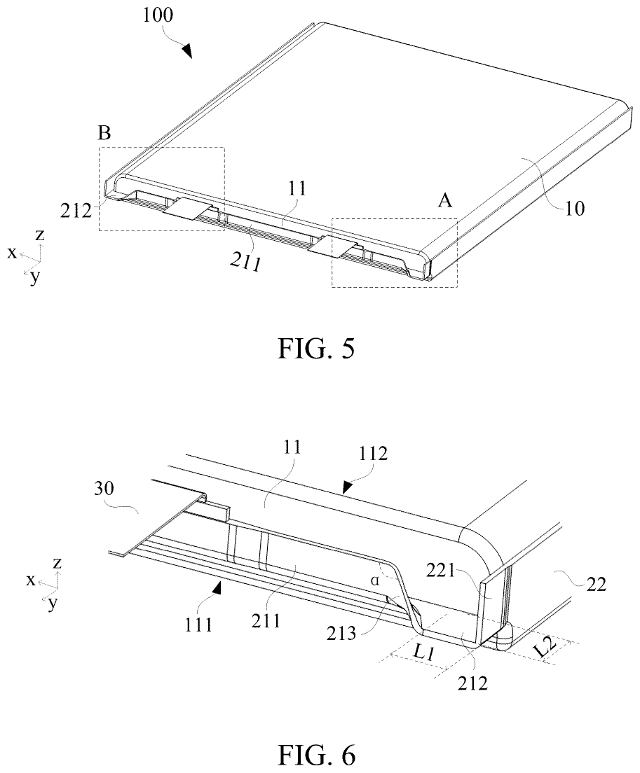

FIG. 5 is a structural schematic diagram of another battery provided in an embodiment of the present application; and FIG. 6 is an enlarged view of region A in FIG. 5.

Referring to FIG. 5 and FIG. 6, when the side of the end portion 212 facing away from the top surface 11 is flat, the side of the end portion 212 facing away from the top surface 11 of the battery cell body 10 and the side of the side sealing edge 22 facing away from the top surface 11 are located in the same plane, and the plane is parallel to the top surface 11 of the battery cell body 10. In other words, when a side of the end portion 212 of the top sealing edge 21 facing away from the top surface 11 is a first side and a side of the side sealing edge 22 facing away from the top surface 11 is a second side, the first side and the second side are located in the same plane, and both are parallel to the top surface 11 of the battery cell body 10. That is, the structure formed by the connection of the end portion 212 and the first end 221 is a flat structure, and there is no sharp angle structure at the position of connecting the end portion 212 and the first end 221. This can further reduce or avoid the sharp angle structure appearing in the packaging member 20, improve the flatness of the packaging member 20, and enhance the safety of the battery 100.

Continuing to refer to FIG. 6, when the side of the end portion 212 facing away from the top surface 11 is flat, in a length direction of the battery cell body 10 (that is, x direction in FIG. 6), a length L1 of the end portion 212 of the top sealing edge 21 may range from 2 mm to 6 mm. The end portion 212 within in this size range can further increase the flatness of the end portion 212, and reduce or avoid the sharp angle structure in the end portion 212.

At the same time, it can also reduce the space occupied by the end portion 212 in the length direction of the battery 100, further improve the size of the battery cell body 10, and improve the energy density of the battery 100.

Continuing to refer to FIG. 6, in the embodiment of the present application, when the side of the end portion 212 facing away from the top surface 11 is flat, the top sealing edge 21 also includes a transition portion 213, where the main body portion 211 and the end portion 212 of the top sealing edge 21 can be connected by the transition portion 213. When the main body portion 211 is bent in the direction of the battery cell body 10 and the end portions 212 at its two sides remain perpendicular to the top surface 11 of the battery cell body 10, two opposite transition portions 213 will be formed between the main body portion 211 and the end portions 212 at two sides thereof respectively, and an incline angle α is formed between each of two transition portions 213 and the main body portion 211.

This can effectively prevent the stress concentration between the main body portion 211 and the end portion 212, reduce or avoid the impact of stress concentration on the connection strength between the main body portion 211 and the end portion 212, thereby effectively improving the connection strength between the main body portion 211 and the end portion 212, and enhancing the stability and reliability of the overall structure of packaging member 20.

Furthermore, continuing to refer to FIG. 6, the incline angle α formed between the transition portion 213 and the main body portion 211 may have a value range from 90° to 150°, and the incline angle α within this value range can further reduce or avoid the phenomenon of stress concentration between the main body portion 211 and the end portion 212, thereby further improving the connection strength between the main body portion 211 and the end portion 212, and enhancing the stability and reliability of the overall structure of the packaging member 20.

Where, the values of two incline angles α formed between the main body portion 211 and the transition portion 213 may be equal, or may not be equal; and there is no limitation in the embodiment of the present application.

Continuing to refer to FIG. 6, when the side of the end portion 212 facing away from the top surface 11 is flat, in the height direction of battery cell body 10 (that is, y direction in FIG. 6), a height L2 of the end portion 212 of the top sealing edge 21 may range from 1 mm to 3 mm. This can further reduce the size of the end portion 212 of the top sealing edge 21 in the height direction of the battery 100, thereby further improving the size of the battery cell body 10, and increasing the energy density of the battery 100.

In the embodiment of the present application, continuing to refer to FIG. 6, in the width direction of the battery cell body 10 (i.e., z direction in FIG. 6), the main body portion 211 of the top sealing edge 21 extends from the first side 111 of the top surface 11 of the battery cell body 10 to the second side 112 of the top surface 11, and the main body portion 211 covers part of the top surface 11. That is, in the width direction of the battery cell body 10, the width size of the main body portion 211 is less than the width size of the top surface 11. This can reduce or avoid that too large width of the main body portion 211 leads to increased width size of the battery 100, prevent the reduced width of the battery cell body 10 caused by the main body portion 211 being too wide, and further improve the size of the battery cell body 10.

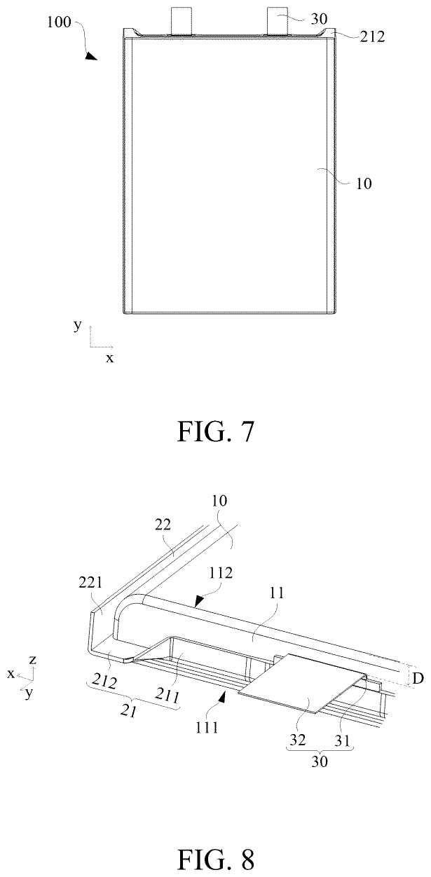

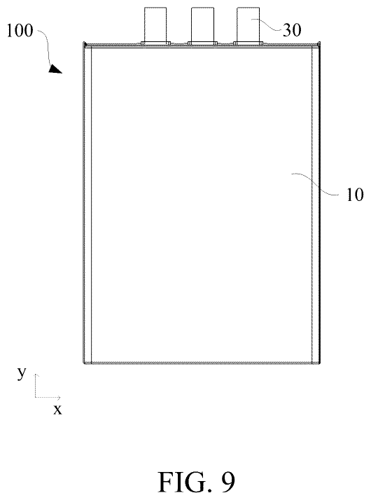

FIG. 7 is a front view of another battery provided in an embodiment of the present application; FIG. 8 is an enlarged view of region B in FIG. 5; and FIG. 9 is a front view of another battery provided in an embodiment of the present application.

Referring to FIGS. 7 and 8, the tab 30 may include a bending part 31 and an extension part 32 that are connected each other, where the bending part 31 is connected with the battery cell body 10, and part of the main body portion 211 encapsulates the bending part 31 of the tab 30, that is, the bending part 31 is encapsulated in the main body portion 211 of the top sealing edge 21. In this way, the top sealing edge 21 can play a certain role in protecting the tab 30, and at the same time, it is also possible to further improve the firmness and reliability of the connection between the tab 30 and the battery cell body 10, and improve the stability of the performance of the battery 100.

Where, when the top sealing edge 21 is bent so that the main body portion 211 is laid on the top surface 11, the bending part 31 of the tab 30 is bent along with the main body portion 211, so that the bending part 31 is also laid on top surface 11, and the extension part 32 is extended parallel to the top surface 11 (refer to the structure in FIG. 8). Then, the extension part 32 can be bent. For example, the extension part 32 can be bent by 90° along a direction facing away from the battery cell body 10, so that the extension part 32 is perpendicular to the top surface 11, that is, the extension part 32 of the tab 30 extends along the height direction of the battery cell body 20 (that is, y direction in FIG. 8).

In this way, it is possible to reduce the space occupied by the tab 30 in the width direction of battery 100 (that is, z direction in FIG. 8), and avoid increasing the size of the tab 30 in the width direction of battery 100 due to the bending of the bending part 31 and the main body portion 211 together, which can effectively prevent the tab 30 from bending or being damaged due to interference in the process of transportation of the battery 100.

At the same time, the extension part 32 of the tab 30 is perpendicular to the top surface 11 of the battery cell body 10, which can facilitate the connection of the tab 30 with other circuit structures of the electronic device, and improve the convenience of the installation of the battery 100.

Continuing to refer to FIG. 8, a distance D between one end of the bending part 31 of the tab 30 facing the second side 112 of the top surface 11 and the second side 112 may be greater than 0.2 mm, in other words, the distance D between a side of the extension part 32 of the tab 30 facing the second side 112 and the second side 112 is greater than 0.2 mm. This can effectively control the size of the bending part 31 of the tab 30 in the width direction (that is, z direction in FIG. 8), and avoid increase of the overall size of the battery 100 in the width direction due to the bending part 31 of the tab 30 being too wide. At the same time, it is also possible to effectively avoid bending or damage to the tab 30 caused by interference during transportation or installation due to excessive width size of the bending part 31.

It should be noted here that the values and ranges of values involved in embodiments of the present application are approximate values, and there may be a certain range of errors due to the influence of the manufacturing process, which can be considered to be negligible by persons of ordinary skill in the art.

In embodiments of the present application, the tab 30 may include a positive electrode tab and a negative electrode tab, where, as shown in FIG. 7, a sum of the number of the positive electrode tab and the number of the negative electrode tab may be two; or the sum of the number of the positive electrode tab and the number of the negative electrode tab may be greater than two. For example, as shown in FIG. 9, the sum of the number of the positive electrode tab and the number of the negative electrode tab may also be three. Specifically, the number of the positive electrode tab and the number of the negative electrode tab can be selected and set according to the specific scene requirements, for example, the number of the positive electrode tab and the number of the negative electrode tab may each also be greater than two.

In the description of the present disclosure, it should be understood that the orientations or position relationships indicated by the terms “center”, “longitudinal”, “transverse”, “length”, “width”, “thickness”, “up”, “down”, “front”, “back”, “left”, “right”, “vertical”, “horizontal”, “top”, “bottom”, “inside”, “outside”, etc. are based on the orientations or position relationships shown in the accompanying drawings, which is only to facilitate the description of the present disclosure and simplify the description, and not to indicate or imply that the device or component referred to must have a specific orientation and be constructed and operated in a specific orientation; and therefore, cannot be interpreted as a limitation to the present disclosure.

In the description of the present disclosure, it should be understood that the terms “including”, “having”, and any variations thereof as used herein, are intended to cover non-exclusive inclusion. For example, a process, a method, a system, a product, or a device that includes a series of steps or units is not necessarily limited to those steps or units clearly listed, but may include other steps or units not expressly listed or inherent to the process, method, product, or device.

Unless otherwise expressly specified and limited, the terms “mounted”, “linked”, “connected”, “fixed”, etc. shall be understood in a broad sense, for example, the connection may be fixed connection, detachable connection, integrated connection, direct connection, indirect connection by an intermediate medium, interconnection between the interiors of two components, or an interaction relationship between two components. For persons of ordinary skill in the art, the specific meanings of the aforesaid terms in the present disclosure can be understood based on specific situations. In addition, the terms such as “first” and “second” are only used for descriptive purposes, and are not to be understood as indicating or implying relative importance, or implicitly specifying the number of the indicated technical features.

Finally, it should be noted that the foregoing embodiments are merely intended for describing the technical solutions of the present disclosure other than limiting the present disclosure. Although the present disclosure is described in detail with reference to the foregoing embodiments, persons of ordinary skill in the art should understand that they may still make modifications to the technical solutions described in the foregoing embodiments or make equivalent substitutions to some or all technical features thereof, and these modifications or substitutions do not make the essence of corresponding technical solutions depart from the scope of the technical solutions of embodiments of the present disclosure.

What is claimed is:

1. A battery, comprising a battery cell body and a packaging member, the packaging member encapsulating the battery cell body, wherein
the packaging member comprises a top sealing edge and side sealing edges located on opposite sides of the top sealing edge, and a first end of each side sealing edge extends to an outer side of a top surface of the battery cell body;
the top sealing edge comprises a main body portion and end portions respectively located on two sides of the main body portion, and the main body portion is disposed on the top surface in a tiled manner;
each end portion is connected to the first end, and a side of the end portion facing away from the top surface is flat;
and/or, the each end portion is attached to an inner side of the first end, and a side of the first end facing away from the top surface is flat.

2. The battery according to claim 1, wherein when the side of the end portion facing away from the top surface is flat, the side of the end portion facing away from the top surface and the side of the first end facing away from the top surface are located in the same plane, and the plane is parallel to the top surface.

3. The battery according to claim 2, wherein in a length direction of the battery cell body, a length of the end portion is 2 mm-6 mm.

4. The battery according to claim 2, wherein the top sealing edge further comprises a transition portion, and the main body portion and the end portion are connected by the transition portion, and an incline angle is formed between the transition portion and the main body portion.

5. The battery according to claim 4, wherein the incline angle between the transition portion and the main body portion has an angle of 90°-150°.

6. The battery according to claim 2, wherein in a height direction of the battery cell body, a height of the end portion is 1 mm-3 mm.

7. The battery according to claim 1, wherein in a width direction of the battery cell body, the main body portion extends from a first side of the top surface to a second side of the top surface, and the main body portion covers part of the top surface.

8. The battery according to claim 2, wherein in a width direction of the battery cell body, the main body portion extends from a first side of the top surface to a second side of the top surface, and the main body portion covers part of the top surface.

9. The battery according to claim 7, further comprising a tab, wherein the tab comprises a bending part and an extension part that are connected each other, the bending part is connected with the battery cell body, part of the main body portion encapsulates the bending part, the bending part is disposed on the top surface in a tiled manner, and the extension part is perpendicular to the top surface.

10. The battery according to claim 8, further comprising a tab, wherein the tab comprises a bending part and an extension part that are connected each other, the bending part is connected with the battery cell body, part of the main body portion encapsulates the bending part, the bending part is disposed on the top surface in a tiled manner, and the extension part is perpendicular to the top surface.

11. The battery according to claim 9, wherein a distance between one end of the bending part facing the second side of the top surface and the second side is greater than 0.2 mm.

12. The battery according to claim 10, wherein a distance between one end of the bending part facing the second side of the top surface and the second side is greater than 0.2 mm.

13. The battery according to claim 9, wherein the tab comprises a positive electrode tab and a negative electrode tab, and a sum of a number of the positive electrode tab and a number of the negative electrode tab is two or more.

14. The battery according to claim 10, wherein the tab comprises a positive electrode tab and a negative electrode tab, and a sum of a number of the positive electrode tab and a number of the negative electrode tab is two or more.
